(19) United States
(12) Patent Application Publication
(10) Pub. No.: US 2001/0017040 A1
(43) Pub. Date: Aug. 30, 2001

(54) Ornamental pendant structure

(76) Inventor: Shao-Chien Tseng, Taoyuan (TW)

Correspondence Address: Keith Kline, PRO-TECHTOR INTERNATIONAL SERVICES, 20775 Norada Court, Saratoga, CA, 95070-3018, US

(21) Appl. No.: 09/791,457

(22) Filed: Feb. 22, 2001

(30) Foreign Application Priority Data
Feb. 25, 2000 (CN) 00205534.1

(51) Int. Cl. B44C 5/00; A44C 13/00; B44C 1/00

(52) U.S. Cl. 63/1.11; 428/28

(57) ABSTRACT

The improved ornamental pendant structure comprises at least some ornamental pieces in an annular housing; wherein, the ornamental pieces are each provided on the periphery thereof with a curved end portion. The housing has on two sides thereof a stop portion and an holding tight portion respectively to receive therebetween the ornamental pieces with a decoration surface thereof revealed but changeable. By pressing rear ones of the ornamental pieces in the housing to push forward the front ones of the pieces to have the latter gotten off the housing, the rear ornamental pieces can all appear their decoration surfaces one by one as a decoration surface of the ornamental pendent. The structure thereby can have a brand-new function of changing its decoration surface; the front ornamental pieces can be stored for use afterwards when they are once more assembled behind the rear ornamental pieces. The structure can further has the function of storing various ornamental pieces, and practical value of the ornamental pendant can be elevated.

### BACKGROUND OF THE INVENTION

1. Field of the invention

The present invention is related to an improved ornamental pendant structure, they are especially suitable to be worn on the necks, hands or feet of people, by the functions of capability of changing and storing various ornaments of the ornamental pendant structure, such ornamental pendant structure can be used by one for changing ornaments in pursuance of mode, fondness or requirement in dressing. Thereby, function and added value of ornamental pendant can be elevated.

2. Description of the Prior Art

Ornamental pendants are a kind of ornament for wearing, and are made mostly of metal, rock, plant or shells etc. On the surface of it is a colorful pattern and a kind of feeling of quality which people are fond of, it can be used to decorate oneself to make outstanding of his or her unique graceful bearing. However, a conventional ornamental pendant only has a single decoration surface, such ornamental pendant is subjected to losing its value of newness by influence of time elapsing and originating of other fashions. Thereby, such ornamental pendant is subjected to being discarded or laying unused and becomes a kind of article de luxe lacking of practical value; youths who are limited in economic capability but fond of making up will accordingly stop being interested in it. This makes the markets of ornamental pendant extremely contracted to form a huge trouble in the art of ornamental pendent.

Accompanying with elevating of life quality day by day, people more and more frequently join the leisure activities of get-together, social gathering, dancing or trip etc. Dressing required in such activities are variant, and often are very different; a conventional ornamental pendant only has a single decoration surface which is in lack of the function of changing the decoration surface; thereby, users have to buy a lot of ornamental pendants suiting various occasions and give themselves troublesome economic heavy burden and reduce their willing of purchasing or using ornamental pendants. Therefore, the art of ornamental pendant is so hard in estimating the markets of ornamental pendant that it is trapped in the dilemma of making clearness in price and cost.

And thereby, a conventional ornamental pendant only has a single decoration surface which is extremely in lack of the function of changing the decoration surface to have made quite inconvenience and trouble for users and manufacturers. Such trouble is exactly the problem which has been studied to solve by and is the motive of the present invention. The inventor of the present invention thereby developed the improved ornamental pendant structure based on his specific technical experience of development for years in metal processing.

### SUMMARY OF THE INVENTION

The primary object of the present invention is to provide an improved ornamental pendant structure which has a function of changing its decoration surface to allow users to change for other decoration surfaces to meet fashion and thus to elevate practical value of the ornamental pendant at their will.

To get the above object, in practice, an ornamental pendant structure is formed from a plurality of ornamental pieces in an annular housing, wherein, the surfaces of the ornamental pieces and the housing can all be printed thereon or coated with required material or processed to endue them with brilliant colorful patterns and a kind of feeling of quality, thereby, ornamental effect can be achieved. By pressing the rear ornamental pieces in the housing to push forward the front ornamental pieces to have the latter gotten off the housing, thereby, the rear ornamental pieces can all appear their decoration surfaces one by one as the decoration surface of the ornamental pendent. The ornamental pendant structure thereby can have a brand-new function of changing its decoration surface; the front ornamental pieces can be stored for use afterwards when they are once more assembled behind the rear ornamental pieces. The ornamental pendant structure can further has the function of storing various ornamental pieces to allow users to change for many kind of decoration surfaces at will in pursuance of various occasions, thereby, practical value of the ornamental pendant can be elevated.

The present invention will be apparent after reading the detailed description of the preferred embodiment thereof in reference to the accompanying drawings.

### BRIEF DESCRIPTION OF THE DRAWINGS

FIG. 1 is a perspective view of the present invention;

FIG. 2 is an analytic perspective view of the present invention;

FIG. 3 is a sectional view of the present invention;

FIG. 4 is a schematic sectional view showing operation of the present invention;

FIG. 5 is a sectional view of another embodiment for storing ornamental pieces of the present invention;

FIG. 6 is a front view of another embodiment of the present invention.

### DETAILED DESCRIPTION OF THE PREFERRED EMBODIMENT

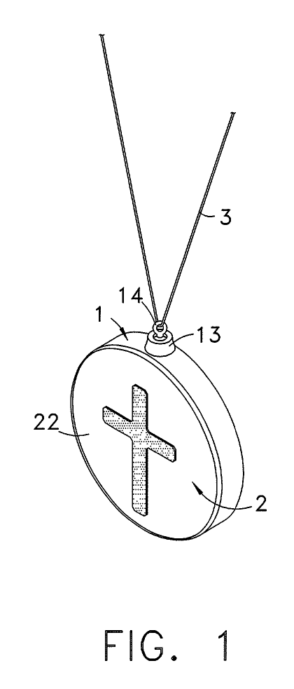

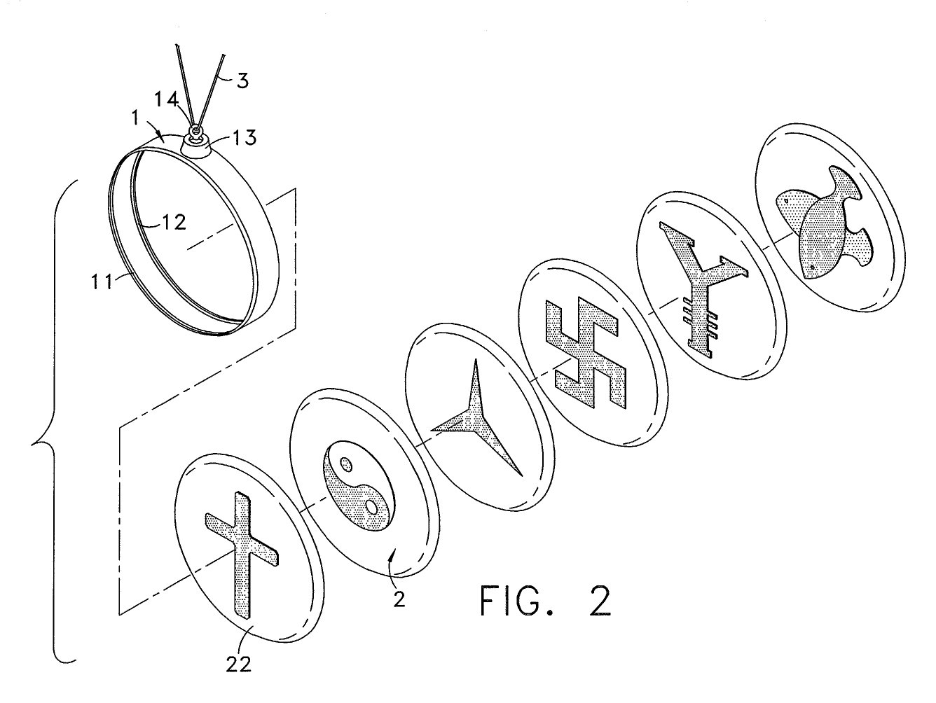

Referring to the FIG. 1 and 2 firstly, the improved ornamental pendant structure of the present invention is comprised at least a plurality of ornamental pieces 2 in an annular housing 1.

Wherein, the ornamental pieces 2 are each provided on the periphery thereof with a curved end portion 21 (referring to FIG. 2, 3) to render the curved end portion 21 easier to get in the housing 1. The surfaces of the ornamental pieces 2 can be made by printing or coating thereon with metal, rock, plant or sea shells etc. or can be made by processing of etching, knurling, polishing or forming fogged surfaces to give the surface 22 of the ornamental pieces 2 a colorful pattern and a kind of feeling of quality which people are fond of. The ornamental pieces 2 can also be made from composite platelets to endue themselves with the visual effect of variety of colors or embossed decorations; thereby, ornamental effect can be achieved.

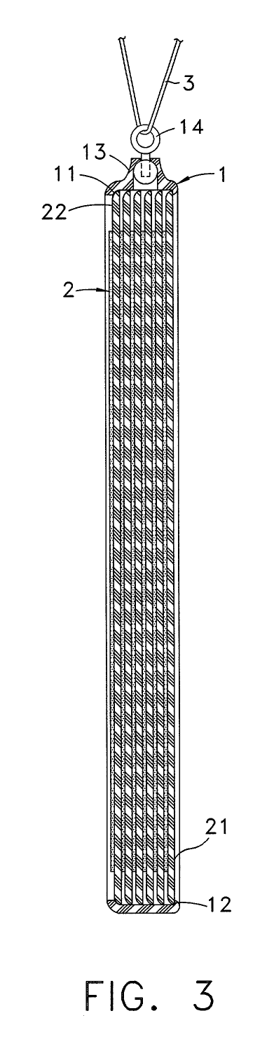

The housing 1 is annular (referring to FIG. 2), one end of it is provided with a pivot 13 which is pivotally provided thereon with a hanging lug 4. The housing 1 is provided on two sides thereof peripherally with an annular stop portion 11 and an annular holding tight portion 12 respectively (referring to FIG. 3) both with flexibility for stretching and contracting. The stop portion 11 and the holding tight portion 12 can receive therebetween the ornamental pieces 2. The surface 15 of the housing 1 is printed or coated thereon with material of metal, rock, plant or sea shells etc. or is processed by etching, knurling, polishing or forming fogged surfaces to give the surface 15 of the housing 1 a brilliant colorful pattern and good quality.

By providing the curved end portions 21 of the ornamental pieces 2, the ornamental pieces 2 can be easily placed in the housing 1 sequentially through the holding tight portion 12 of the housing 1 (referring to FIG. 3). And the curved end portions 21 of the ornamental pieces 2 are also stopped and held by the stop portion 11 and the holding tight portion 12 of the housing 1, thereby the ornamental pieces 2 can be received between the stop portion 11 and the holding tight portion 12, and the lateral side of the stop portion 11 of the housing 1 can have a brilliant colorful pattern and good quality (referring to FIG. 1), and thereby an ornamental pendant structure is formed.

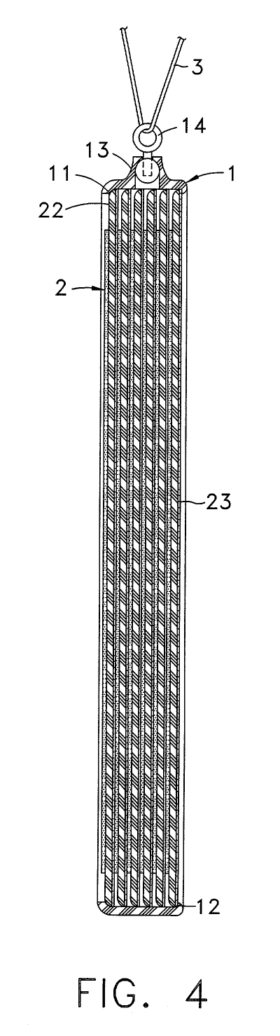

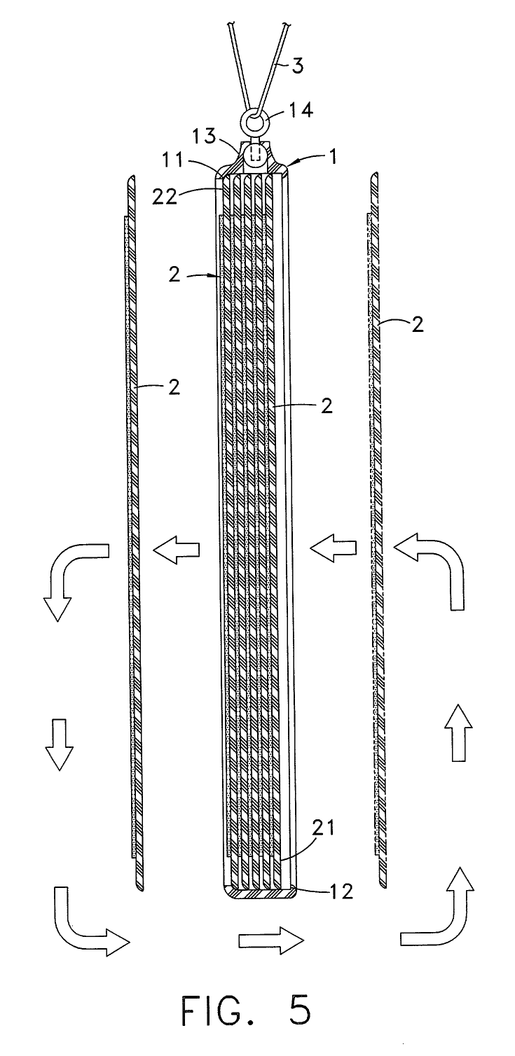

When a user wears the ornamental pendant, the ornamental pieces 2 can be rotated to change their orientations in the drawings to make the ornamental pendant a pleasure visual effect. When the user desires to change the decoration surface of the ornamental pendant structure, by pressing the rear ones (marked as 2 in FIG. 5) of the ornamental pieces 2 through pressing the side with the holding tight portion 12 of the housing 1, the rear ornamental pieces 2 pushes the front ornamental pieces 2 by the function of the curved end portions 21 to render the latter to pass the stop portion 11 and get off the housing 1; in this way, the ornamental pendant structure can get another decoration surface (referring to FIG. 4), and can have a brand-new function of changing its decoration surface.

The front ones of the ornamental pieces 2 having gotten off the housing 1 can once more be placed in the housing 1 again by the function of the curved end portions 21 between the stop portion 11 and the holding tight portion 12 of the housing 1 (referring to FIG. 5) for use afterwards. Therefore, the ornamental pendant structure can have various decoration surfaces to be changed in pursuance of the mood, fondness or arrangement of dressing to suit various occasions, thereby, practical value of the ornamental pendant can be largely elevated.

The ornamental pieces 2 of the present invention can also be stuck on the back surfaces thereof with a pad each to protect the surfaces of the ornamental pieces 2 in the housing 1. For example, as shown in FIG. 4, a plurality of ornamental pieces 2 are stuck on the back surfaces thereof with a plastic pad 23 each, thereby, when the ornamental pieces 2 are engaged in the housing 1, the surfaces of the ornamental pieces 2 can be pressed against the plastic pads 23 in order to prevent damage of abrading of the surfaces of the rear ornamental pieces 2 against the back surfaces of the front ornamental pieces 2. This can increase durability of the ornamental pieces 2. And by selection of the material for the pads, the surfaces of the ornamental pieces 2 can be processed by embossing to make the embossed areas a special visual effect on the surfaces of the ornamental pieces 2 by showing a characteristic of quality of the pads.

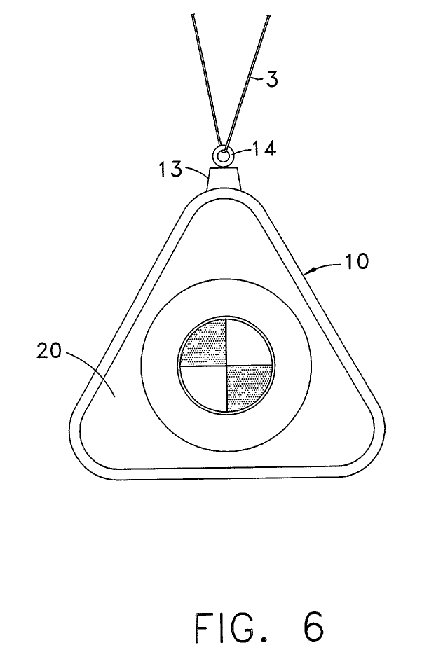

And more, the annular housing 1 can also be in the shape of an ellipsoid, a polygon, a rectangle or a triangle etc.; for example, a housing 10 and ornamental pieces 20 can all be in the shape of triangles (referring to FIG. 6) to render the ornamental pendant structure to show a mysterious feeling.

In conclusion, the improved ornamental pendant structure with the ornamental pieces thereof changeable surely has the novel effect of changing its decoration surface, and has the improved functions of storing various decoration surfaces; it largely increases the practical value of ornamental pendent.

Having thus described my invention, what I claim as new and desire to be secured by Letters Patent of the United States are:

1. An improved ornamental pendant structure, comprising at least:
a plurality of mutually changeable ornamental pieces, Wherein, said ornamental pieces are each provided on the periphery thereof with a curved end portion;
an annular housing which is annular, said housing is provided on two sides thereof with an annular stop portion and an annular holding tight portion respectively both with flexibility for stretching and contracting, said stop portion and said holding tight portion receive therebetween said ornamental pieces.

2. An improved ornamental pendant structure as claimed in claim 1, wherein,
said ornamental pieces are stuck on the back surfaces thereof each with a pad.
